(19) United States
(12) Patent Application Publication
(10) Pub. No.: US 2009/0163313 A1
(43) Pub. Date: Jun. 25, 2009

(54) DIFFERENTIAL ASSEMBLY WITH TWO JOINTLY ACTUATED AXIAL ADJUSTMENT DEVICES

(75) Inventors: Theodor Gassmann, Siegburg (DE); Mark Schmidt, Konigswinter (DE); Kai Sorge, St. Augustin (DE); Kurt Muller, Merzenich (DE); Ralph Mertens, Kaarst (DE)

Correspondence Address: GKN Driveline/TTG, c/o Kristin L. Murphy, 39533 Woodward Avenue, suite 140, Bloomfield Hills, MI, 48304, US

(73) Assignee: GKN DRIVELINE INTERNATIONAL GMBH, LOHMAR, DE (DE)

(21) Appl. No.: 12/158,653

(22) PCT Filed: Dec. 2, 2006
(86) PCT No.: PCT/EP2006/011587

§ 371 Date: Nov. 5, 2008

(30) Foreign Application Priority Data
Dec. 20, 2005 (DE) 10 2005 061 267.9

(51) Int. Cl. F16H 48/30

(52) U.S. Cl. 475/150

(57) ABSTRACT

A differential assembly 2 for variable torque distribution in the drive line of a motor vehicle. A differential gear 21 with a rotationally drivable differential cage 4 and two output shafts 3, 3′, which are drivingly connected to the differential cage 4 by means of a differential gear set 7, 9, 9′, wherein a first drive train is formed. A gear stage 14, 14′ per output shaft 3, 3′, which gear stage is drivingly connected on one side to the differential cage 4 and on the other side to one of the output shafts 3, 3′ is part of a second drive train which is functionally parallel to the first drive train. Friction clutch 15, 15′ are provided for each gear stage 14, 14′ and ball ramp assemblies are provided for actuating the friction clutches, the ball ramp assembly having a plurality of ball grooves 44, 45; 44′, 45′ of variable depth. A single electric motor 52 is drivingly connected to rotatably driveable discs 43; 43′ of axial setting devices 16, 16′.

The invention relates to a differential assembly for variable torque distribution in the drive line of a motor vehicle, which comprises a differential with an input shaft and two output shafts, which have a balancing effect on each other. The manner in which the differential assembly for variable torque distribution functions is such that part of the torque introduced via the input shaft is branched off from the differential cage before being distributed to the two output shafts; the branched-off torque fraction is additionally induced on one of the two output shafts after the distribution of the remaining torque. A gear stage and a friction clutch are provided per output shaft for this purpose. The gear stage comprises an input gear, which is driven by the differential cage and accelerates or slows an output gear. Coupling the output gear to the associated output shaft of the differential accelerates or slows the latter. In this manner, a greater torque can be transmitted to one of the two output shafts than to the other of the output shafts as required in order to increase the driving stability of the motor vehicle. Such differential assemblies can be used for distributing the torque between the two side shafts of an axle differential, as is disclosed for example in DE 103 42 164 A1, or for the controlled distribution of the torque between the two axle shafts of a centre differential of a multi-axle-driven motor vehicle.

WO 2005/035294 A1 discloses a drive assembly of a motor vehicle with two driven axles, which can in each case be coupled to an output shaft of the gearbox by means of a separate friction clutch. To actuate the friction clutches, actuator technology is provided, which comprises an electric motor and two ball-type linear drives, which are driven by it. The ball-type linear drives comprise in each case a nut and a spindle, of which one component is in functional connection with an associated set of plates. The spindles are adjusted in opposition to one another, depending on the direction of rotation of the electric motor. This means that when the electric motor rotates in a first direction, the first clutch is closed while the second clutch is opened. On actuation of the electric motor in the opposite direction, the second clutch is closed and the first clutch is opened.

DE 101 60 026 A1 discloses an axial setting device with a double function. The axial setting device is part of an intermediate axle gear assembly, which comprises a stepped gearbox and a differential gear, which can be locked by means of a friction clutch. The axial setting device is in the form of a ball ramp assembly and comprises a central disc, a first outer disc for acting on the friction clutch and a second outer disc for acting on a gear sleeve for the stepped gearbox. A single electric motor for rotating the discs is provided, wherein either the central disc is driven while the outer discs are held in a rotationally fixed manner, or the outer discs are driven synchronously while the central disc is held in a rotationally fixed manner.

The object of the present invention is to propose a differential assembly with two friction clutches for variable torque distribution between two shafts in the drive line of a motor vehicle, which assembly has short response times, has a simple construction and can be manufactured in a cost-effective manner.

A solution according to the invention consists in a differential assembly for variable torque distribution in the drive line of a motor vehicle, comprising a differential gear with a rotationally drivable differential cage and two output shafts, which are mounted on a rotational axis and are drivingly connected to the differential cage by means of a differential gear set, wherein a first drive train is formed between the differential cage and each of the output shafts; a gear stage per output shaft, which gear stage is drivingly connected on one side to the differential cage and on the other side to one of the output shafts and is part of a second drive train, which is functionally parallel to the first drive train; a friction clutch per gear stage for coupling and decoupling the second drive train; an axial setting device per friction clutch in the form of a ball ramp assembly for actuating the friction clutch, with in each case two discs which are coaxial with respect to the rotational axis and of which one is supported axially and the other is axially displaceable, and of which one is rotationally driveable, wherein the two discs have on their facing end faces a plurality of ball grooves, which—viewed in each case from above onto the end faces—have a variable depth in the same circumferential direction, wherein in each case one ball is accommodated in pairs of ball grooves, which are located opposite one another; and a single electric motor, which is drivingly connected to the rotationally drivable discs of both axial adjustment devices.

The advantage of the differential assembly according to the invention is that it manages with a lower number of parts, since only a single electric motor is provided, which actuates both axial setting devices. This also means a smaller installation space of the assembly as well as a lighter weight. The ball grooves of the two axial setting devices are preferably designed to be variable in depth in such a manner that an actuation of the electric motor in one direction of rotation causes the two discs of the first axial setting device to move away from each other, while the two discs of the second axial setting device maintain the same axial distance from one another. Driving the electric motor in the opposite direction first causes the two discs of the first axial setting device to come closer to one another, and after a neutral position has been passed, causes the two discs of the second axial setting device to move away from one another. While the discs of the second setting device are axially spread, the discs of the first axial adjustment device maintain their distance from one another.

According to a preferred embodiment, the ball grooves of the rotationally driveable discs—viewed in each case from above onto the end faces—have a variable depth in the same circumferential direction, wherein the electric motor is drive-connected to the rotationally driveable discs in such a manner that the latter are always rotated in the same direction of rotation. If the ball grooves for the two driven discs have the same configuration, it is particularly favourable for manufacturing in the sense of a carry-over-parts concept. An embodiment with rotational direction changing stages is however also conceivable, in which the two driven discs are driven in different rotational directions on actuation of the electric motor. For this purpose, the ball grooves of the two driven discs—viewed in each case from above onto the end faces—would have to have a variable depth in the opposite circumferential direction. The axially supported discs of the two axial setting devices are preferably held in each case in a rotationally fixed manner in the housing, whereas the axially displaceable discs can in each case be rotationally driven by the electric motor.

It is furthermore provided that the ball grooves of the two discs of the two axial adjustment devices have in each case an idling section of uniform depth and an adjoining active section of variable gradient. A neutral point is preferably defined between the idling section and the active section. According to a preferred development, the idling sections are in each case as long as or longer than the active sections, in order to guarantee complete functionality of the ball ramp assembly over the entire length of the active regions. The balls are thus prevented from running along the opposite ball ramp assembly against end stops of the idling regions. The ball grooves of the two axial setting devices are designed in such a manner that on actuation of the electric motor—starting from the neutral point—the balls of one axial adjustment are guided into the idling sections, while the balls of the other axial adjustment device are guided into the active sections. According to a preferred embodiment, the neutral point is formed by locking recesses, which are arranged in the ball grooves of at least one of the two ball ramp assemblies in each case in the transition region between the active sections and the idling sections and into which the associated balls can lock. As a result of the defined neutral point, the system can be calibrated during operation so that an optimum dosing of the locking torque for the friction clutch can always take place. This means that particularly precise interventions in the driving dynamics of the motor vehicle are achieved so that a high level of driving stability is ensured.

According to a preferred embodiment, the active sections of the two axial adjustment devices have in each case a first part section of relatively large gradient and an adjoining second part section of relatively small gradient. The first part section preferably extends over a smaller circular arc section than the second part section. The advantage of this embodiment is that—starting from the neutral point, in which the two discs have the axially shortest distance from each other—a large axial travel over the angle of rotation is initially covered in the actuated disc, in order to overcome the play of the set of plates. This produces a particularly short system response time. The second part section which adjoins the first part section has a relatively shallow gradient so that a relatively small axial travel over the angle of rotation is produced here. This second part section is used for controlling the friction clutch in its working region. The shallow gradient produces a sensitive adjustment of the axial adjustment device and thus particularly precise control of the friction clutch. Because the first groove section extends over a smaller circular arc section than the second groove section, a particularly short response time on the one hand and a particularly sensitive control in the working region on the other hand is possible.

In concrete terms, the electric motor has an output shaft, which is drive-connected via an intermediate gear with the rotationally driveable discs of the two axial setting devices. The intermediate gear preferably comprises an intermediate shaft, which runs parallel to the rotational axis. This produces an assembly which can be installed in a radially compact manner. The electric motor is preferably arranged axially in the region of one of the two friction clutches, namely the first or the second friction clutch.

The friction clutches of the differential assembly according to the invention can be configured to be stationary, that is, they are held in a positionally fixed manner with respect to a stationary housing. In this case the gear stage revolves around the rotational axis. The gear stage preferably then comprises in each case a first sun gear, which is connected in a rotationally fixed manner to the differential cage, a second sun gear, which is connected in a rotationally fixed manner to the output shaft, at Least one planetary gear, which meshes with the two sun gears, and a carrier element, which supports the at least one planetary gear and can revolve around the longitudinal axis. The stationary friction clutch comprises in each case outer plates, which are connected in rotationally fixed manner to the housing, and inner plates, which are connected to the link element of the gear stage. According to an alternative embodiment, the friction clutches can also be configured such that they rotate about the rotational axis. In this case the gear stage is arranged in a positionally fixed manner in the housing.

A preferred exemplary embodiment is explained below using the drawing. In the figures,

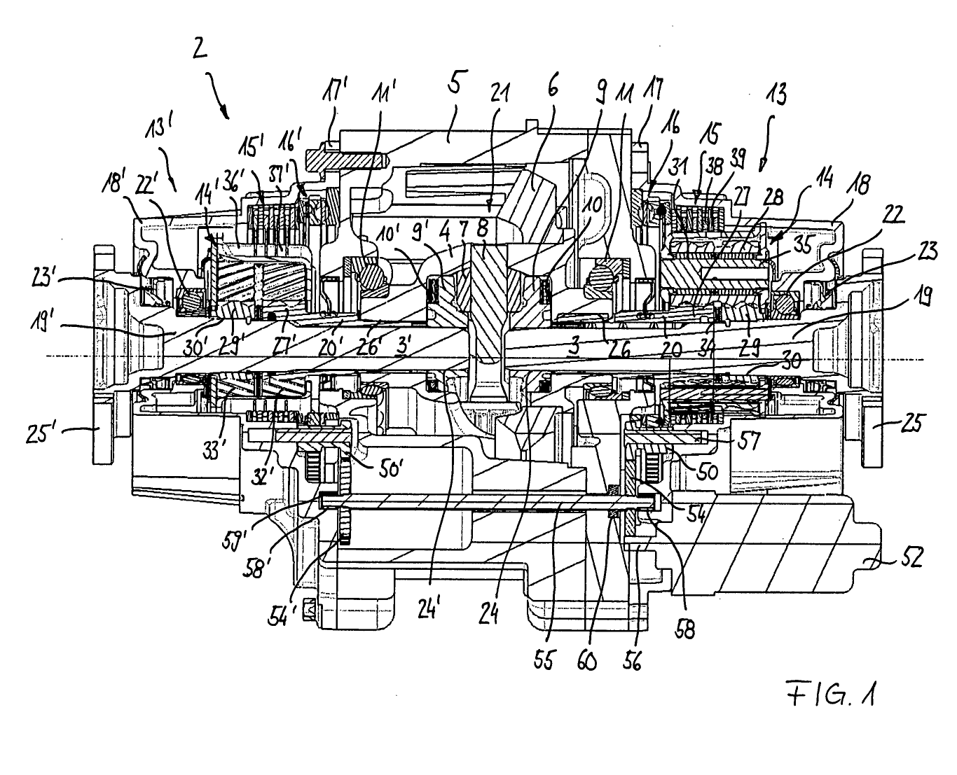

FIG. 1 shows the differential assembly according to the invention in longitudinal section;

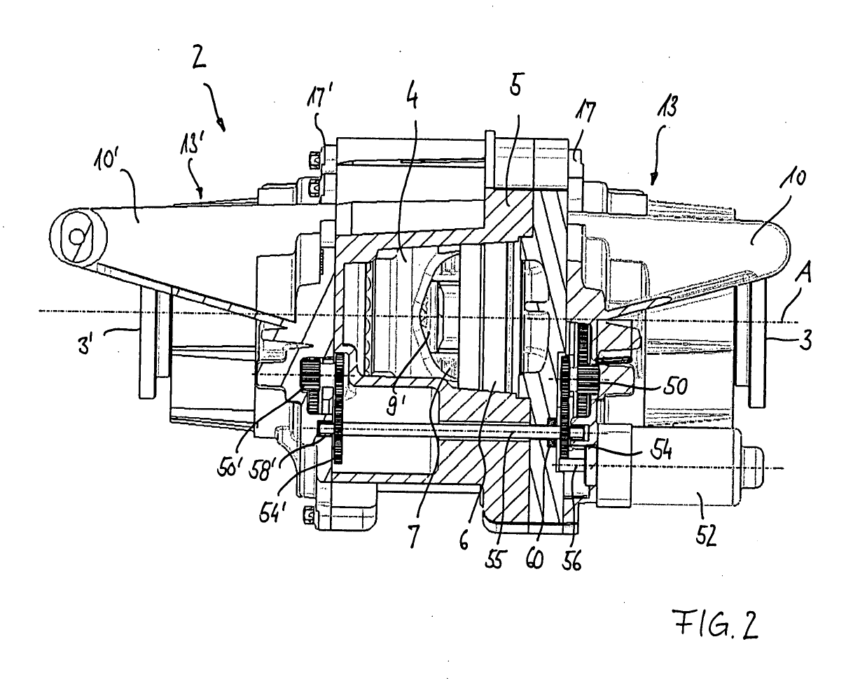

FIG. 2 shows the differential assembly from FIG. 1 in longitudinal section through another sectional plane;

FIG. 3 shows the friction clutch/ball ramp unit from FIG. 1 as a detail in longitudinal section;

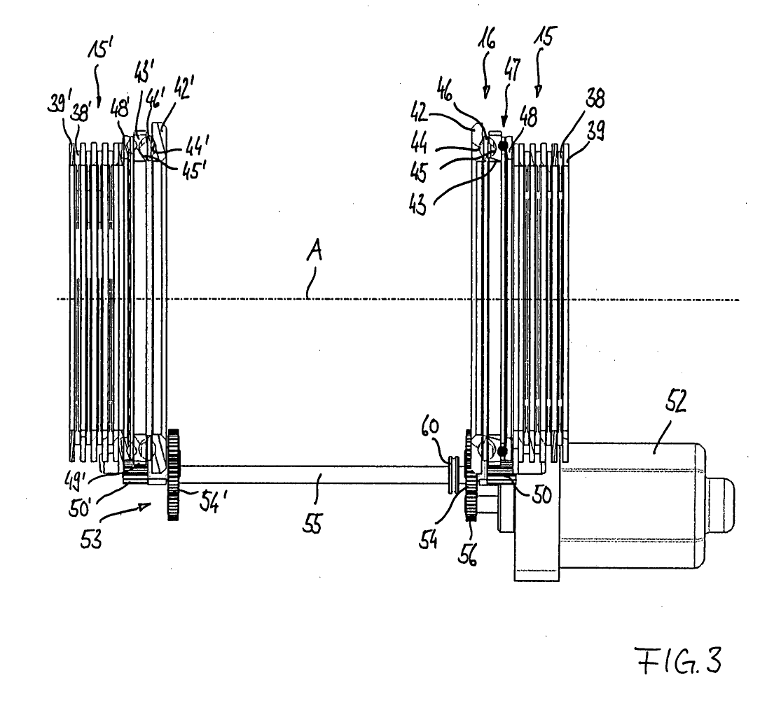

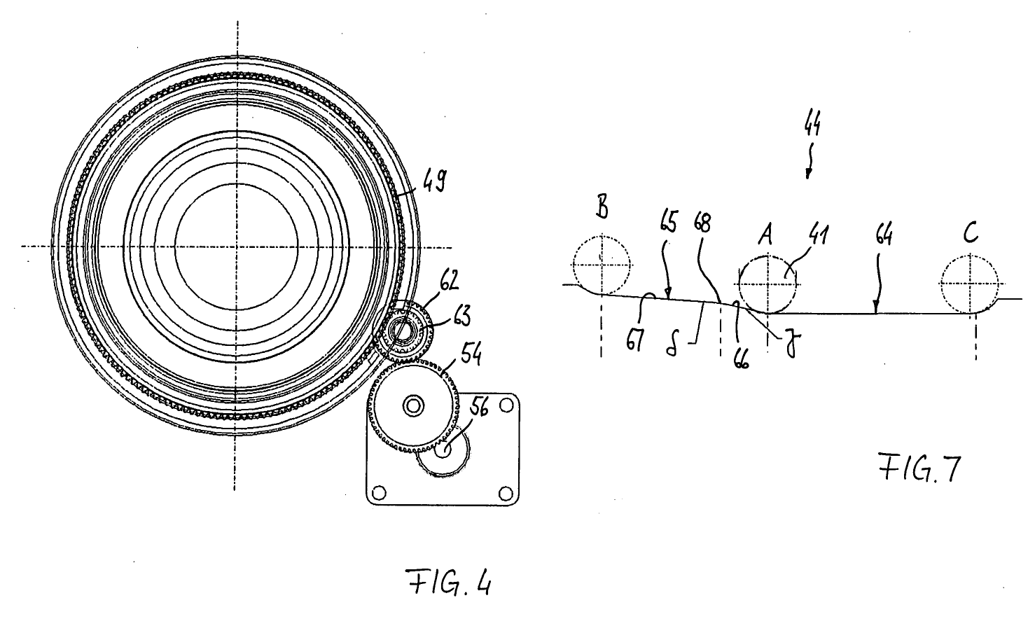

FIG. 4 shows the friction clutch/ball ramp unit from FIG. 1 as a detail in cross section;

FIG. 5 shows the setting disc of the first ball ramp assembly from FIG. 1 in plan view;

FIG. 6 shows the supporting disc associated with the setting disc from FIG. 5 in plan view;

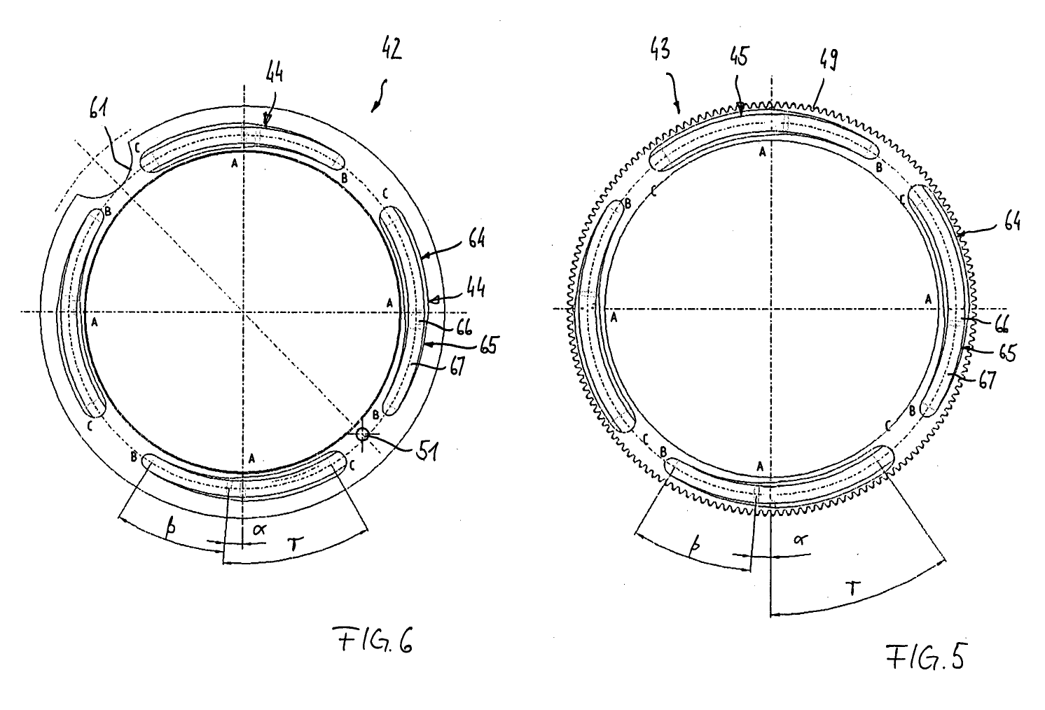

FIG. 7 shows a circumferential section through the base of a ball groove of the setting disc from FIG. 5 or the supporting disc from FIG. 6;

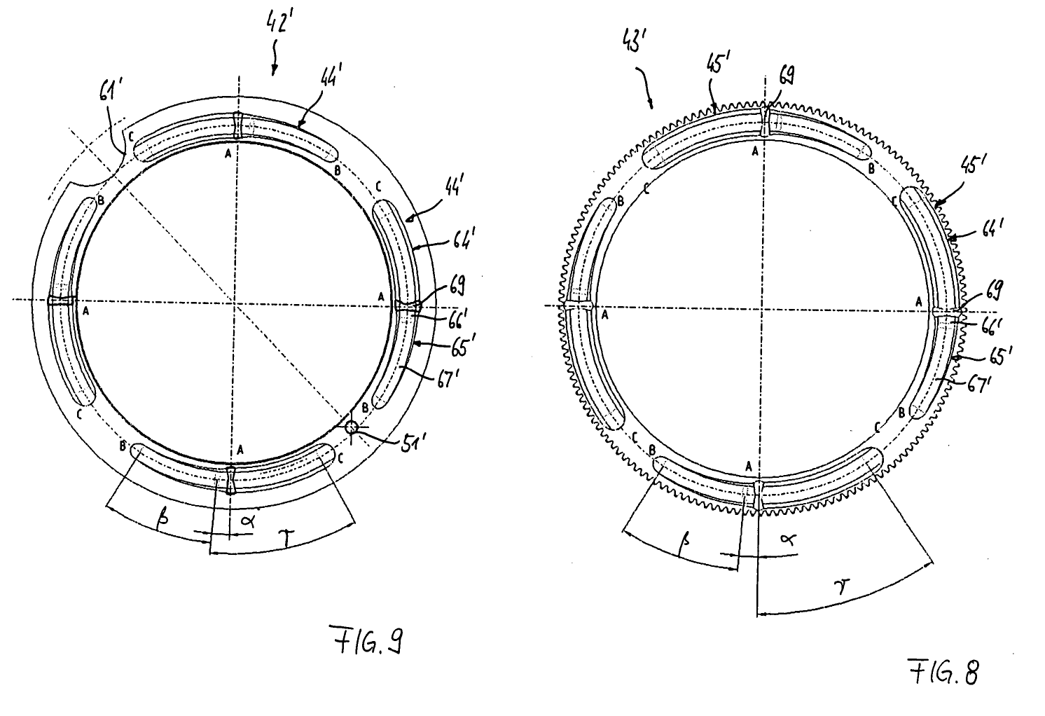

FIG. 8 shows the setting disc of the second ball ramp assembly from FIG. 1 in plan view;

FIG. 9 shows the supporting disc associated with the setting disc from FIG. 8 in plan view;

FIGS. 1 and 2 are described together below. A differential assembly 2 for variable torque distribution in the drive line of a motor vehicle is shown. The differential assembly 2 is driven by a stepped gearbox (not shown here) via a drive shaft, and the incoming torque is distributed to two side shafts 3, 3′. The differential assembly 2 comprises a differential cage 4, which is mounted by means of rolling bearings 11, 11′ in a stationary differential housing 5 such that it can rotate about the rotational axis A. A ring gear 6 is fixed to the differential cage 4, which ring gear is driven by the drive shaft of the motor vehicle. In the differential cage 4, a plurality of differential gears 7, which revolve with the differential cage 4, are rotatably mounted on journals 8, which are perpendicular to the rotational axis A. The differential gears 7 mesh with two side shaft gears 9, 9′, which are in turn connected in a rotationally fixed manner to in each case one associated side shaft 3, 3′. The differential gears 7 and the side shaft gears 9, 9′ together form a differential gear set for transmitting torque from the differential cage 4 to the side shafts 3, 3′. A first drive train is thus formed in each case between the differential cage 4 and the side shafts 3, 3′. The differential drive is designed in the form of a conical differential, wherein the differential gears 7 are spur gears and the side shaft gears 9, 9 are crown gears. Axial bearings 10, 10′ are provided in each case between the crown gears and the differential cage 4 to support the spreading forces. The brackets 12, 12′, which are only visible in FIG. 2, are connected integrally with the differential housing 5 and are used to bind the gear housing to the body of the motor vehicle.

A gear module 13, 13′ for variable torque distribution is provided per side shaft 3, 3′ laterally adjacent to the differential drive 21. As the gear modules are constructed the same, the same components have the same reference numbers, with the reference numbers of the left gear module 13, 13′ being provided with primes. The gear modules 13, 13′ comprise as assemblies in each case a gear stage 14, 14′, a friction clutch 15, 15′ and an axial setting device 16, 16′. The gear stage 14, 14′ is drivingly connected on one side to the differential cage 4 and to an associated side shaft 3, 3′ on the other side. It is part of a second drive train, which is functionally parallel to the first drive train. The axial setting device 16, 16′ is arranged coaxially with respect to the rotational axis A and is used for actuating the friction clutch 15, 15′, which is coaxial to the respective axial setting device. The friction clutch 15, 15′ controls the parallel second drive train and can open or close the latter, as a result of which the torque distribution between the side shafts 3, 3′ changes. The gear modules 13, 13′ are in each case connected by means of flange connections 17, 17′ to the differential housing 5. Since both gear modules correspond to each other with regard to their construction and manner of functioning, only one is described by way of example.

The gear module 13 comprises a housing 18, a first shaft 19, 19′, which is mounted rotatably inside it on the rotational axis A and is configured to be integral with the respective side shaft 3, 3′, and a second shaft 20, 20′, which is mounted so that it can rotate coaxially on the first shaft. The first shaft 19, 19′ is mounted rotatably in the housing 18 by means of a rolling bearing 22, 22′ and sealed off with respect to the housing by means of a shaft sealing ring 23, 23′. The first shaft 19, 19′ has on the input side longitudinal toothing 24, 24′, which is placed in a rotationally fixed manner in corresponding counter-toothing in the associated side shaft gear 9, 9′. The first shaft has on the output side a flange 25, 25′ for connection to an axle shaft (not shown here) of the motor vehicle. The second shaft 20, 20′, which is in the form of a hollow shaft and is rotationally supported on the first shaft 19, 19′, has longitudinal toothing 26, 26′, which is placed in a rotationally fixed manner in corresponding counter-toothing on the differential cage 4.

The gear stage 14, 14′ comprises a first sun gear 27, 27′, which is connected integrally to the hollow shaft 20, 20′, a plurality of planetary gears 28, which mesh with the first sun gear 27, 27′, and a second sun gear 29, 29′, which meshes with the planetary gears and is connected in a rotationally fixed manner to the first shaft via longitudinal toothing 30, 30′. The planetary gears 28 are in each case designed in one piece and comprise two toothing sections 32, 33; 32′, 33′, of which one is engaged meshingly with the first sun gear 27, 27′ and the other is engaged meshingly with the second sun gear 29, 29′. An axial bearing 34, 34′ is provided between the two sun gears. In order to achieve a rotary speed ratio between the first shaft and the hollow shaft supported on it, the two sun gears have a different number of teeth. The numbers of teeth of the planetary gears 28 and of the sun gears are selected in such a manner that a rotary speed difference of up to 15% is achieved between the first shaft and the hollow shaft. The planetary gears 28 are accommodated in a rotatable manner by means of needle bearings 31 on journals 35 in a carrier element 36, 36′. The carrier element 36, 361 has a cage-shaped design and is largely closed towards the outside. Engagement means are provided on the outer circumferential face 37, 37′ of the carrier element 36, 36′, into which engagement means the inner plates 38, 38′ of the friction clutch 15, 15′ engage in a rotationally fixed manner.

The friction clutch 15, 15′ comprises in addition to the inner plates 38, 38′, which are held on the rotational axis A in an axially displaceable manner, outer plates 39, 39′, which are coaxial to the inner plates and are held in an axially displaceable manner longitudinally with respect to the rotational axis A and in a rotationally fixed manner with respect to the housing 18. The outer plates 39, 391 and the inner plates 38, 38′ are arranged in such a manner that they alternate axially and together form a set of plates, which is supported axially with respect to the housing 18. Actuation of the friction clutch 15, 15′ causes the rotating carrier element 36, 36′ of the gear stage 14, 141 to be braked with respect to the positionally fixed housing 18, 18′, in order to receive an additional torque directly at the differential cage 4 and transmit it via the parallel second drive train, that is, the hollow shaft 20, 20′ and the gear stage 14, 14′, to the corresponding side shaft 3, 3′.

The friction clutch 15, 15′ is controlled by means of the associated axial setting device 16, 16′, which is designed as a ball ramp assembly and has two discs 42, 43; 42′, 43′, which are coaxial with respect to the rotational axis A, in order to generate the necessary clutch torque. The first of the discs is designed as a supporting disc 42, 421, which is supported axially and held in a rotationally fixed manner with respect to the differential housing 5. The second disc is designed as an axially displaceable and rotationally driveable setting disc 43, 43′. The two discs in each case have on their end faces, which are facing each other, a plurality of ball grooves 44, 45; 44′, 451 of oppositely variable depth, which are distributed over the circumference and run in the circumferential direction. In each pair of ball grooves 44, 45; 44′, 45′ situated opposite each other, a ball 41 is accommodated, by means of which the two discs support each other. The setting disc 43, 43′ is mounted radially with respect to the supporting disc 42, 42′ exclusively by means of the balls 41, while the supporting disc is fixed in the differential housing 5. An annular disc-shaped cage 46 with windows distributed over the circumference is provided axially between the two discs. One of the balls 41 is accommodated in each window and the balls are in this way held at a defined position with respect to each other in the circumferential direction.

In the basic condition, that is, when the friction clutch 15, 15′ is completely open, the setting disc 43, 43′ and the supporting disc 42, 42′ are in the closest possible position to each other. When the setting disc 43, 431, which is discussed in more detail below, rotates correspondingly, the balls 41 run in the regions of smaller depth. The discs are thus spread apart, with the setting disc 43, 43′ being displaced axially towards the friction clutch 15, 15′. The setting disc 43, 43′ has on its rear side a radial pressure face, which acts on a pressure plate 48, 48′ by means of an interposed axial bearing 47, 47′. The axial bearing 47, 47′ is designed as a ball bearing, with first bearing grooves being provided in the pressure face of the setting disc 43, 43′ and second bearing grooves being worked into the opposite face of the pressure plate 48, 48′. The pressure plate 48, 48′ bears axially against the set of plates and acts upon the latter with an axial force in the closing direction when the ball ramp assembly is actuated. An actuation of the ball ramp assembly thus leads to a predefined locking of the friction clutch 15, 15′ and a coupling of the revolving gear stage 14, 14′ to the stationary housing 18, 18′. To open the friction clutch 15, 15′ again, the setting disc 43, 43′ is actuated in the opposite direction. Pressure springs, which are supported axially in the gear housing and act upon the setting disc 43, 43′ (and are not visible in the present section), cause the setting disc 43, 43′ to return towards the supporting disc 42, 42′.

The setting disc 43, 43′ is provided on its outer circumferential face with outer toothing 49, 49′ in order to achieve a rotary movement of the former. A pinion 50, 50′, which is rotatably mounted in the housing 18, 18′ and drive-connected to an electric motor 52, engages in the outer toothing 49, 49′. The special feature of the present invention is that only one electric motor 52 is provided for rotating the setting disc 43 of the first friction clutch 15 and for rotating the setting disc 43′ of the second friction clutch 15′. The electric motor 52 is flanged onto the housing 18 and drive-connected by means of an intermediate gear 53, 53′ to the two setting discs 43, 43′ of the ball ramp assemblies.

As can be seen in particular in FIGS. 3 and 4, the intermediate gear 53, 53′ comprises two gears 54, 54′ and an intermediate shaft 55, with which the two gears are connected in a rotationally fixed manner to opposite ends of the intermediate shaft. The rotationally fixed connection is usually made by means of a spline. The gear 54 on the motor side meshes on one side with the drive journal 56 of the electric motor 52 and thus drives the intermediate shaft 55; on the other side it meshes with the pinion 50, which is mounted rotatably in the housing 18 and engages in turn with the outer toothing 49 of the setting disc 43 of the ball ramp assembly on the motor side. The pair of gears of the opposite drive is constructed in the same manner. The left gear 54′, which sits on the intermediate shaft 55, engages with the teeth of an associated pinion 50′, which is mounted rotatably in the housing 18, and in turn engages with the outer toothing 49′ of the setting disc 43′ of the second ball ramp assembly. The two pinions 50, 50′ are held rotatably by means of sliding bearings on a pin 57, 57′, which is inserted in the respective housing part 18, 18′. It can be seen that the intermediate shaft 55 is mounted rotatably at its outer ends in housing bores 59, 59′ by means of needle bearings 58, 58′. The gears 54, 54′ are arranged axially with a small distance adjacently to the bearing points, in order to keep the transverse forces acting on the intermediate shaft 55 low. On the motor side, the intermediate shaft 55 is sealed off from the housing cover by means of a sealing ring 60. The lubricant spaces between the gear module 13 on the motor side for the right-hand output shaft 3 and the oppositely directed gear module 13′ for the left-hand output shaft 3′ are separated in this manner.

The unit consisting of the electric motor 52, intermediate gear 53, 53′, right-hand and left-hand ball ramp assembly and right-hand and left-hand friction clutch 15, 15′ is shown in FIG. 3. The friction clutches are unactuated, so that the setting discs 43, 43′ and the supporting discs 42, 42′ of the two ball ramp assemblies in each case have a very small axial distance from each other. The balls 41 of the two ball ramp assemblies are not visible in this figure, since they can be found in other sectional planes. The toothings of the two pinions 50, 50′ can be seen, which extend over a greater axial length than the respective setting disc 43, 43′, in order to stay engaged with the outer toothing when the setting disc is displaced axially. In FIG. 4, the said components or parts of them can be seen in plan view. It can be seen that the pinion 50 has a first toothing section 62 of relatively large diameter, which meshes with the gear 54, and a second toothing section 63 of relatively small diameter, which engages with the outer toothing 49 of the setting disc 43.

FIGS. 5 and 6 show the supporting disc 42 and the associated setting disc 43 of one of the two ball ramp assemblies. It can be seen that four ball grooves 44, 45 per disc 42, 43 are provided, which are distributed over the circumference and are designed to be diametrically opposed, that is, have in each case the same profile in the circumferential direction. The setting disc 43 has a bore 51, into which a securing pin for fixing in a rotationally fixed manner is to be placed. A recess 61 is provided approximately diametrically opposite, past which the associated pinion 50 is guided. FIG. 7 shows a ball groove 44, representing both discs 42, 43, in circumferential section through the base of the groove. It can be seen that the ball groove 44 has an idling section 64 of uniform depth and an adjoining active section 65 of starting from the idling section reducing depth. The idling section 64 extends over a larger arc section (γ) than the arc section (α+β) of the active section 65. The idling section 64 and the active section 65 of the first ball ramp assembly 16 are arranged in such a manner in relation to the idling section 64′ and the active section 65′ of the second ball ramp assembly 16′ that—starting from a neutral point—the balls of one ball ramp assembly run into the active sections while the balls of the second ball ramp assembly run into the idling sections on actuation of the electric motor in a first direction of rotation. When the electric motor 52 is driven in the opposite direction, the balls of the second ball ramp assembly run into the active sections while the balls of the first ball ramp assembly run into the idling sections. When the balls are in the idling sections 64, 64′, the corresponding discs 42, 43; 42′, 43′ have the smallest distance from one another and the associated friction clutch 15, 15′ is in the unactuated condition. In the active sections 65, 65′ of the discs, in contrast, the discs are displaced axially away from each other so that the associated friction clutch 15, 15′ is actuated.

The active sections 65, 65′ of the two ball ramp assemblies 16, 16′ comprise in each case a first part section 66, 66 or active region of relatively large gradient and an adjoining second part section 67, 67′ or active region of relatively small gradient. The first active region 66, 66′ extends over a circular arc section a of up to 50 with a linear gradient of approximately 5° to 10°. This first active section 66, 66′ is relatively steep so that a large travel over the angle of rotation is covered. This is favourable in order to—starting from the unactuated condition—overcome the play of the friction clutch 15, 15, quickly. The second active region 67, 67′ extends over a circular arc β of up to 30° with a linear gradient of approximately 1.5° to 2.5°. The shallow rise of the second active region is particularly favourable for the working region of the friction clutch 15, 15′ in order to be able to adjust the friction torque precisely. A connecting transition region 68, 68′ is provided between the two active regions 66, 67; 66′, 67′, which is curved with a small radius and has a relatively short length. The idling section 64, 64′ has an arc section γ of up to 35°. This is greater than the arc section of the active section 65, 65′ so that the functionality of the ball ramp assembly is retained over the entire length of the active sections without it being hindered by end stops of the opposite ball ramp assembly. It is self-evident that the circular arc sections and gradients of the active regions depend on the number of ball grooves distributed over the circumference. This can also be a number other than four.

FIGS. 8 and 9 show the discs 42′, 43′ of the second ball ramp assembly. Their construction and function correspond largely to those of the first ball ramp assembly. Reference is made in this respect to the above description with regard to the common features. The only difference between the present discs is that locking recesses 69 are provided between the idling sections 64′ and the active sections 65′ of the ball grooves 44′, 45′, in which recesses the corresponding balls 41 can lock. These locking recesses 69 are used to calibrate the system during operation, that is, to define a neutral point. The locking recesses 69 are in each case designed in the form of grooves, which run transversely with respect to the ball groove and viewed in circumferential section through the groove base are concavely curved and have a smaller radius than the balls 41. The balls 41, which are in the neutral point are thus viewed in circumferential section through the groove base supported at two points and thus held in a defined circumferential position. This neutral point of the balls 41 is designated ‘A’ in FIGS. 8 and 9, while the ball positions with greater axial spreading are designated ‘B’ and the ball positions in end positions within the idling sections are designated ‘C’.

The ball ramp assemblies 16, 16′ have an extremely short response time and a sensitive working region, with regular calibration of the system by means of neutral point definition also guaranteeing precise control for the entire service life. The gear modules 13, 13′ thus permit an exact regulation of the drive torques of the motor vehicle.

The use of a single electric motor 52 for both ball ramp assemblies 16, 16′ has the advantage of a low number of parts and a compact construction. The assembly is set out in such a manner that—starting from the neutral point—the balls 41 of the first ball ramp assembly run into their active sections while the balls 41 of the second ball ramp assembly run into their idling sections on actuation of the electric motor 52 in a first direction of rotation. The first friction clutch 15 is thus actuated in the closing direction. If the electric motor 52 is driven in the opposite direction of rotation, the second ball ramp assembly—after the neutral point has been passed again—is spread while the first ball ramp assembly is in the idling condition. The second friction clutch 151 is thus actuated in the closing direction. Only one of the two friction clutches 15, 15′ for variable torque distribution is therefore actuated at once, while the other friction clutch 15′, 15 is open and has no influence on torque distribution.

1. A differential assembly (2) for variable torque distribution in the drive line of a motor vehicle, said assembly comprising
a differential drive (21) with a rotationally drivable differential cage (4) and two output shafts (3, 3′), said output shafts mounted on a rotational axis (A) and a drivingly connected to the differential cage (4) by a differential gear set (7, 9, 9′), wherein a first drive train is formed between the differential cage (4) and each of the output shafts (3, 3′);
a gear stage (14, 14′) for each of said output shafts (3, 3′), said gear stages being drivingly connected on one side to the differential cage (4) and on the other side to one of said output shafts (3, 3′) and is part of a second drive train, which is functionally parallel to said first drive train;
a friction clutch (15, 15′) in each gear stage (14, 14′) for coupling and decoupling the second drive train;
an axial setting device (16, 16′) in each friction clutch (15, 15′) in the form of a ball ramp assembly for actuating each of said friction clutches, each of said ball ramp assemblies having two discs (42, 43; 42′, 43′) which are coaxial with respect to the rotational axis (A) and of which one is supported axially and the other can be axially displaced, and of which one can be driven rotationally, wherein the two discs have on their facing end faces a plurality of ball grooves (44, 45; 44′, 45′), which have a variable depth in the same circumferential direction, wherein in each case one ball (41) is accommodated in pairs of ball grooves (44, 45; 44′, 45′), which are located opposite one another; and a single electric motor (52), which is drivingly connected to the rotationally drivable discs (43; 43′) of each of said both axial setting devices (16, 16′).

2. The differential assembly according to claim 1, wherein the ball grooves (44, 45; 44′, 45′) of said two axial setting devices (16, 16′) are designed to be variable in depth in such a manner that an actuation of the electric motor (52) in a first direction of rotation causes said two discs (42, 43; 42′, 43′) to come closer to one another, whereas said two discs (42′, 43′; 42, 43) of the other axial setting device (16′, 16) maintain the same distance with respect to each other, and vice versa.

3. A differential assembly according to claim 1, wherein the ball grooves (45; 45′) of said rotationally driveable discs (43; 43′) of said two axial setting devices (16, 16′) have a variable depth in the same circumferential direction, wherein the electric motor (52) is drivingly connected in such a manner to the rotationally driveable discs (43; 43′) that the latter are rotated in the same direction of rotation on actuation of the said electric motor (52).

4. The differential assembly according to claim 1, wherein the axially supported discs (42; 42′) of the two axial setting devices (16, 16′) are in each case held in a rotationally fixed manner in the housing (5) and that the axially displaceable discs (43; 43′) of the two axial setting devices (16, 16′) are each rotationally driveable by said electric motor (52).

5. The differential assembly according to claim 1, wherein the ball grooves (44, 45; 44′, 45′) of the two discs (42, 43; 42′, 43′) of the two axial setting devices (16, 16′) have in each case an idling section (64, 64′) of uniform depth and an adjoining active section (65, 65′) of variable gradient.

6. The differential assembly according to claim 5, wherein said idling section (64, 64′) extends over at least an equally sized arc section to said active section (65, 65′).

7. The differential assembly according to claim 5, wherein a neutral point is defined between said idling section (64, 64′) and active section (65, 65′).

8. The differential assembly according to claim 7, said ball grooves (44, 45; 44′, 45′) of the two axial setting devices (16, 16′) are designed in such a manner that, starting from the neutral points, the balls (41) of one axial setting device (16, 16′) are guided into said idling sections (64, 64′), whereas the balls (41) of the other axial setting device (16′, 16) are guided into said active sections (65′, 65) on actuation of the electric motor (52).

9. The differential assembly according to claim 7 or 8, the wherein said neutral point is formed by locking recesses (69), which are provided in said ball grooves (44, 45; 44′, 45′) of at least one of said axial setting devices (16, 16′) in the transition region between said active section (65, 65′) and said idling section (64, 64′) and in which the associated balls (41) can catch.

10. The differential assembly according to claim 5, wherein said active sections (65, 65′) of said two axial setting devices (16, 16′) have in each case a first section (66, 66′) of relatively large gradient and an adjoining second section (67, 67′) of relatively small gradient.

11. The differential assembly according to claim 10, wherein said first section (66, 66′) extends over a smaller circular arc (α) than said second section (67, 67′).

12. The differential assembly according to claim 1, wherein said electric motor (52) has a drive journal (56), which is drivingly connected by means of an intermediate gear (53) to said rotationally driveable discs (43; 43′) of said two axial setting devices (16, 16′).

13. The differential assembly according to claim 12, wherein said intermediate gear (53) comprises an intermediate shaft (55), which runs parallel to the rotational axis (A).

14. The differential assembly according to claim 1, wherein said electric motor (52) is arranged axially in the region of one of said two friction clutches, namely the first or the second friction clutch (15, 15′).

15. The differential assembly according to claim 1, wherein said gear stage (14, 14′) comprises per output shaft (3, 3′) in each case a first sun gear (27, 27′), which is connected in a rotationally fixed manner to the differential cage (4), a second sun gear (29, 29′), which is connected in a rotationally fixed manner to the associated output shaft (3, 3′), at least one planetary gear (28, 28′), which meshes with the two sun gears (27, 29; 27′, 29′), and a carrier element (36, 36′), which supports the at least one planetary gear (28, 28′) and can revolve around the longitudinal axis (A); and that said friction clutch (15, 15′) has per gear stage (14, 14′) in each case outer plates (39, 39′), which are connected in a rotationally fixed manner to the housing (18, 18′), and inner plates (38, 38′), which are connected to the carrier element (36, 36′) of the gear stage (14, 14′).
